(19) United States
(12) Patent Application Publication
(10) Pub. No.: US 2017/0338975 A1
(43) Pub. Date: Nov. 23, 2017

(54) VEHICLE COMMUNICATION SYSTEM

(71) Applicant: Whitlow G. Elzner, Austin, TX (US)

(72) Inventor: Whitlow G. Elzner, Austin, TX (US)

(21) Appl. No.: 15/600,131

(22) Filed: May 19, 2017

Related U.S. Application Data
(60) Provisional application No. 62/338,688, filed on May 19, 2016.

(51) Int. Cl. H04L 12/40; G06F 3/16; H04L 29/08; H04L 25/20

(52) U.S. Cl. CPC H04L 12/40006; H04L 67/12; G06F 3/167; H04L 25/20; H04L 2012/40273

(57) ABSTRACT

A vehicle communication system for use in a vehicle having a vehicle bus. The vehicle communication system includes a display unit, a processing unit, and a relay device. The display unit provides a display screen and a receiver for receiving messages from the processing unit to be displayed on the display screen. Further, the processing unit, having means for voice recognition and dictation, includes a transmitter for sending messages to the receiver and a plurality of controls for selecting and inputting the desired message. The relay device is in electrical communication with the vehicle bus for receiving information as to the brakes, turn signals, and transmission of the vehicle, wherein the relay device powers the display unit when the transmission of the vehicle is started and displays a predetermined message on the display screen when the brakes and turn signals are engaged. The processing unit can further be operated via a remote device.

### CROSS-REFERENCE TO RELATED APPLICATION

This application is a completion application which claims the priority benefit of co-pending U.S. Provisional Patent Application Ser. No. 62/338,688, filed May 19, 2016, for “Vehicle Communication System,” the entire disclosure of which, including the drawing, is hereby incorporated by reference.

### BACKGROUND OF THE INVENTION

### 1. Field of the Invention

The present invention pertains to communication systems. More particularly, the present invention concerns communication systems for displaying a visual message. Even more particularly, the present invention pertains to vehicular associated communication systems for displaying a visual message.

### 2. Description of Prior Art

As the country's population is ever increasing, there is an increasing number of motor vehicles, such as trucks, vans, and delivery vehicles, that are crowded onto our already crowded roadways.

As the number of these vehicles increases, it is becoming more and more important to improve safety measures and quality of travel for all of those on the road. In either high-speed or congested travel, it is important that as much relevant information as possible concerning operation of a vehicle be communicated to other nearby vehicles when necessary, such as noticeable brake lights, hazard lights, and turning signals. Law enforcement officers recognize this importance and, therefore, oftentimes write citations for having a broken taillight or failing to properly signal. In addition, it is important that information be communicated to following vehicles concerning conditions the following vehicles may encounter, such as icy roads, fallen trees, or an accident ahead.

This information must be communicated quickly and easily to avoid the driver of the vehicle from becoming distracted while selecting a message and must be able to be read quickly by passing vehicles in order to avoid any distraction to them as well.

Moreover, advertising on vehicles is becoming more common where banners are attached to the sides of vehicles, bumper stickers on the rear, or advertisements atop the vehicle as is typical with cabs, delivery vehicles, and the like. There is a need to enhance these commercial messages in a noninvasive manner, including being able to send an advertising message from a remote source, such as a company's headquarters or advertising firm.

Various systems for automobile-to-automobile communication devices have been disclosed, for example, in U.S. Pat. No. 7,952,489 to Paterno; U.S. Pat. No. 7,569,808 to Cooper et al.; U.S. Pat. No. 5,905,434 to Steffan et al.; and U.S. Pat. No. 4,868,542 to Thompson. Generally, these systems involve physically selecting a predetermined message to be communicated from one vehicle to another or automatic signals being sent from the vehicle, such as brake lights or turn signals.

As vehicles are becoming more and more computer based to facilitate vehicle diagnostics, most vehicles manufactured after 1996 provide for a diagnostic port or vehicle bus where a plug can be inserted in order to monitor, record, and report useful information about the vehicle and driving habits. Some of the above references disclose integration with the vehicle bus in order to display vehicle alerts and notifications.

Requiring hands-on operation in order to provide and select these messages increases the risk of an accident being caused while driving. The above references do not have the capability to be reprogrammed and activated using alternative means other than physical, hands-on operation by the user of the vehicle.

Furthermore, the above references fail to disclose any means for controlling the messages to be displayed from a remote source other than a device from within the confines of the vehicle or hardwired thereto. This leaves the control of the messages to be displayed completely under the discretion of the driver. In certain situations, such as where the driver is an employee of a company owning the vehicle being driven and seeks to maintain advertising control, it is desirable to provide such control to one out of range from the vehicle communication system.

While the prior art references pertaining to vehicular message display systems disclosed above may be suitable for the particular purpose to which they address, they would not be as suitable for the purposes of the present invention as described hereafter. What is needed is a vehicle communication system that reduces the amount of attention and operation required by the driver in selecting a message and may be operated by one outside of range from the system.

It is to this to which the present invention is directed.

The above references are identified herein in recognition of a duty of disclosure of related subject matter, which may be relevant under 37 CFR 1.56, and specifically incorporated, herein by reference as regards the conventional approaches and constructions taught therein.

### SUMMARY OF THE INVENTION

The present invention provides a vehicle communication system for delivering a variety of visual messages from one vehicle to another, or a nearby pedestrian, concerning traffic conditions, emergencies, or any other desired topic of communication to be made with those in close proximity.

In a first embodiment, a vehicle communication system for use in a vehicle having a vehicle bus, generally, comprises: (a) a display unit including a housing having a plurality of sides and an open interior, a display screen for displaying a message provided within one of the sides of the housing, a receiver for receiving a remote signal disposed within the interior of the housing and in electrical communication with the display screen; (b) a processing unit including means for voice recognition and dictation, a transmitter for sending a signal to the receiver, a plurality of controls for selecting and inputting a message disposed on the processing unit and in electrical communication with the transmitter; (c) a relay device in electrical communication with the vehicle bus for receiving information as to the brakes, turn signals, and transmission of the vehicle the relay device sending a signal to the receiver of the display unit in order to power the display screen and the receiver when the transmission of the vehicle is started and displaying a predetermined message when the brakes or turn signals are engaged.

The relay device wirelessly sends a signal to the receiver of the display unit in order to power the display unit when the transmission of the vehicle is started and to display a predetermined message when the brakes or turn signals are engaged.

The display unit and the processing unit can either be in electronic communication with the battery of the vehicle in order to receive power therefrom or, alternatively, the display unit and/or the processing unit can each include a separate power supply for providing its own source of power.

Furthermore, the transmitter and the receiver can be in electrical communication with one another to facilitate messages being sent from the processing unit to the display unit or, alternatively, the receiver and transmitter can operate wirelessly.

In a second embodiment, a vehicle communication system for use in a vehicle having a vehicle bus, generally, comprises: (a) a display unit including a housing having a plurality of sides and an open interior, a display screen for displaying a message provided within one of the sides of the housing, a receiver for receiving a remote signal disposed within the interior of the housing and in electrical communication with the display screen; (b) a processing unit including means for voice recognition and dictation, a transmitter for sending a signal to the receiver, a plurality of controls for selecting and inputting a message disposed on the processing unit and in electrical communication with the transmitter; and wherein the receiver receives a signal from the vehicle bus in order to power the display screen and the receiver when the transmission of the vehicle is started and to display a predetermined message when the brakes or turn signals are engaged.

According to this second embodiment, in order to receive information as to the vehicle's brakes, turn signals, and transmission, either the display unit or the processing unit is in direct electronic communication with the vehicle bus.

If the display unit is in electrical communication with the vehicle bus, then the display unit receives such information and displays a message associated with the relevant information on the display screen.

Alternatively, where the processing unit is in direct electronic communication with the vehicle bus, the processing unit receives the information and transmits such information to the receiver of the display unit, which displays an associated message on the display screen.

For a better understanding of the present invention, reference is made to the accompanying drawing and detailed description. In the drawing, like reference characters refer to like parts through the several views, in which:

### BRIEF DESCRIPTION OF THE DRAWING

FIG. 1 is a layout of a first embodiment of the present invention;

FIG. 2 is the same view as FIG. 1 having a separate power supply; and

FIG. 3 is a layout of a second embodiment of the present invention.

### DETAILED DESCRIPTION OF THE INVENTION

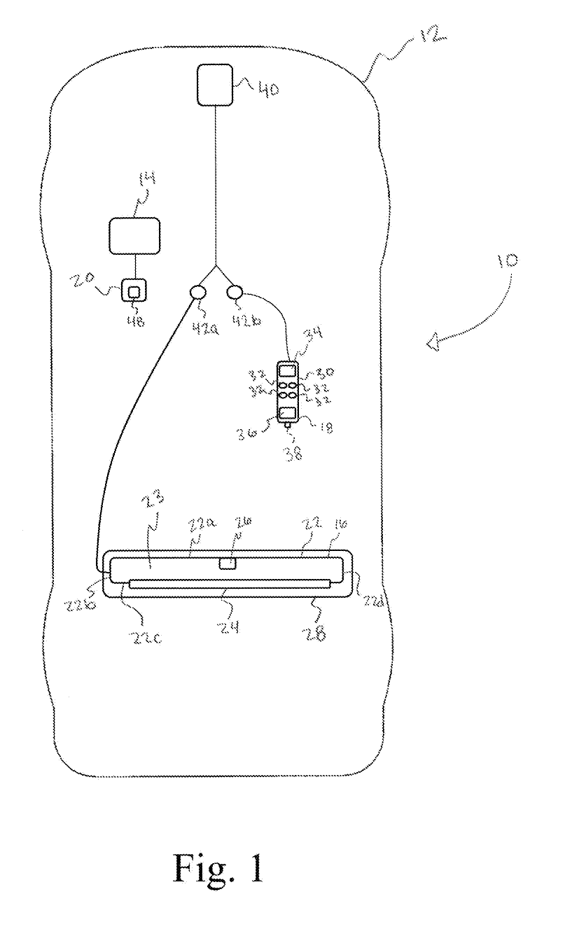

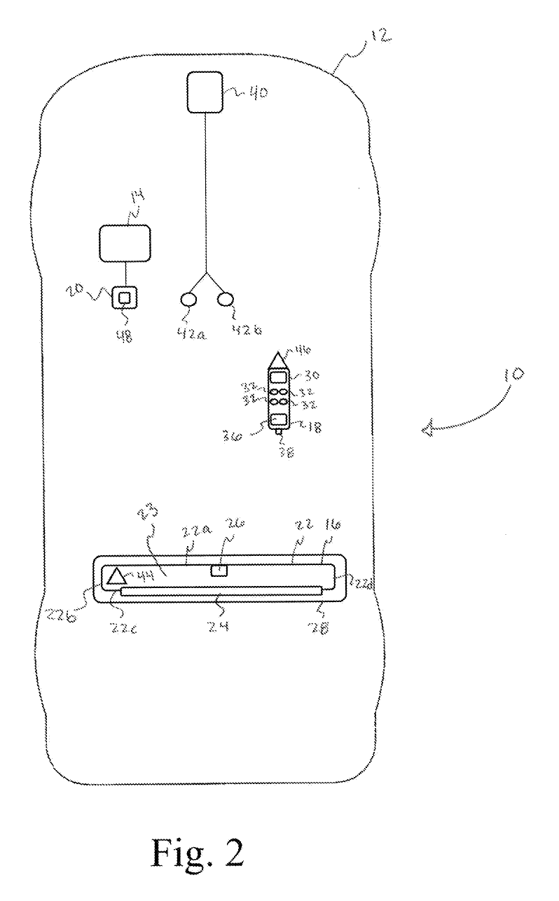

Now, and in accordance with a first embodiment of the present invention and with reference to FIGS. 1 and 2, there is provided a vehicle communication system, generally, denoted at 10, for use in a vehicle 12 having a vehicle bus 14. The vehicle bus 14 is a conventional bus, which monitors a number of functions of the vehicle 12 such as the transmission, brakes, turn signals, and the like. The vehicle communication system 10, generally, comprises: (a) a display unit 16 for displaying messages and receiving said messages from a remote source; (b) a processing unit 18 having means for voice recognition and dictation for sending messages to the display unit 16; and (c) a relay device 20 for receiving information from the vehicle bus 14 and delivering predetermined displayable messages to the display unit 16 based on that information.

The display unit 16 includes an elongated housing 22 having a plurality of sidewalls 22a, 22b, 22c, 22d, which cooperate to define an interior 23 therein. As noted below, the display unit 16 is preferably mounted proximate the rear of the vehicle 12 so that it can viewed from the rear, as discussed below. The housing 22 comprises a highly durable material to prevent tampering, such as steel, nickel, iron, and the like.

An elongated display screen 24 is disposed and secured within a sidewall 22c of the housing 22 so that messages displayed thereon are easily viewed by trailing vehicles or pedestrians. The display screen 24 is any commercially available display device that illustrates a message having both uppercase and lowercase text that rotates, slides, and/or flashes as it is displayed. The text of the message is intended to be displayed in at least red and green. Preferably, the display screen 24 can display text in a combination of both red and green, along with a variety of other colors. The display screen 24 is either a segmented display or full area 2-dimensional display. Preferably, the display screen 24 is a segmented display typical in most digital clocks having either a seven-segment display, fourteen-segment display, or sixteen-segment display. Therefore, the display screen 24 comprises any suitable technology to illustrate the text such as incandescent filaments, vacuum fluorescent display, cold cathode gas discharge, light-emitting diode (LED), liquid crystal display (LCD), and the like. Preferably, the display screen 24 utilizes an LED display.

The display unit 16 further comprises a receiver 26 disposed within the interior 23 of the housing 22 and in electrical communication with the display screen 24. As noted below, the receiver 26 receives a signal and converts these signals into text messages to be sent to the display screen 24 and display the message thereon. The receiver 26 is a commercially available receiver capable of receiving a signal and further deliver the signal to the display screen 24.

The receiver 26 of the display unit 16 further includes the additional ability to receive a signal, not only from the processing unit 18 discussed below, but also a remote source such as a personal computer, mobile phone, and the like. This provides specific utility where one desires to display a message on the vehicle 12 while not within range to operate the processing unit 18. For example, a parent may choose to display a message that the driver just recently received their license and to approach with caution. Alternatively, a company, such as a realtor, taxi service, and the like, may want to maintain control over advertisements streaming on the display screen 24. These messages being delivered to the receiver 26 from an outside source will have priority over those messages being selected on the processing unit 18. These preferences may be modified from within a settings menu of the system 10.

To facilitate mounting the display unit 16 and providing improved security thereto, a protective casing 28 surrounds the entirety of the display unit 16 and is mounted by any suitable fastening means, such as brackets, bolts, and the like, to a desired portion on the vehicle 12, such as the interior, rear deck, roof, and the like, instead of mounting the display unit 16 to the vehicle 12 directly. The protective casing 28 comprises any suitable high-tensile material, such as tempered glass, fiberglass, plexiglass, polyurethane, and the like, which provides a clear viewing window to the display screen 24 so as to not hinder the visibility of the messages. The protective casing 28 prevents tampering with and disabling of the display unit 16 when mounted on either the interior or exterior of the vehicle 12. Furthermore, the protective casing 28 protects the display unit 16 when mounted on the exterior of the vehicle 12 from water damage and debris while on the road.

The display unit 16, and thus the display screen 24 and the receiver 26 disposed therein, is either powered by the battery 40 of the vehicle 12 or it includes its own power supply.

As shown in FIG. 1, the display unit 16 is in electrical communication with the battery 40 of the vehicle 12 via a standard vehicular power socket 42a. These power sockets 42a are typically 12V plugs used to charge devices such as GPS devices, phones, radar detectors, and the like. Alternatively, the display unit 16 may plug into a USB port, AC plug, and the like if the vehicle 12 provides for such inputs.

As shown in FIG. 2, in an alternative arrangement, the display unit 16 further comprises a power supply 44 disposed within the housing 22. This provides for a wireless display unit 16 having more flexibility as to where it can be mounted without being restricted by any wiring. Furthermore, by having its own power supply 44, the display unit 16 is no longer a drain on the battery 40 of the vehicle 12.

Preferably, each time the display unit 16 is started, an initial message is displayed on the display screen 24 that discloses the name of the system 10 and where it can be purchased. This message is selected at the time of manufacturing. The user is not able to modify or remove this message.

As noted above, the messages are transmitted to the receiver 26 of the display unit 16 by way of the processing unit 18. The processing unit 18 resembles that of a remote control comprising a body 30, a plurality of controls 32 disposed on the body 30 for user operation, a miniature display screen 34 disposed on the body 30, and a transmitter 36 provided within the body 30 for sending a signal to the receiver 26 of the display unit 16.

The plurality of controls 32 are in electrical communication with the transmitter 36. The plurality of controls 32 allow the user to type messages where each button corresponds to numbers 0-9 and letters A-Z, similar to that of a number keypad on a phone. Further, it is to be understood that the plurality of controls 32 includes other relevant buttons corresponding to power, enter/select, arrows, and the like.

Using the plurality of controls 32, the processing unit 18 allows the user to select from a wide variety of stored messages either built in to the processing unit 18 at the time of manufacturing or created by the user. Although not shown in the drawing, the processing unit 18 further comprises at least one memory bank embedded within a microchip, PC board, or the like, and disposed in the processing unit 18, for storing these messages. Preferably, there are at least three separate memory banks, wherein each memory bank includes at least 50 channels for storing different messages. The first of the three memory banks is intended to store 48 safety related messages and 2 anti-theft messages that cannot be changed or erased by the user. The remaining two memory banks are open for the user to store their own personalized messages in channels 51 through 100 and 101 through 150, respectively. While the user has the ability to input and store their own messages, the memory banks include a filtering system for declining messages that are defined as vulgar, racist, and/or obscene.

As noted above, the processing unit 18 is also voice activated having means for voice recognition and dictation, which allow the user to input and select messages verbally instead of having to type them in manually. It is to be understood that any suitable commercially available speech recognition software embedded within a microchip, PC board, or the like is easily incorporated into the processing unit 18. Having the means for voice recognition and dictation reduces the time required in selecting a message and, thus, the amount of distraction to the driver.

The processing unit 18 further comprises a microphone 38 that provides an audio input to deliver verbal commands to the memory banks. In order to select or dictate a message to be displayed, or stored for later use, the user speaks into the microphone 38 of the processing unit 18.

For safety precautions, the processing unit 18 includes a lock out function that prevents the user from creating new messages when the vehicle 12 is moving. Permitting messages to be added while driving leads to too many distractions and is not safe to the driver. Therefore, only messages previously stored in the memory banks may be selected while the vehicle 12 is in motion.

Once the user has selected a message to be displayed on the display screen 24 using the plurality of controls 32 and/or any verbal commands, the message is delivered to the transmitter 36. The transmitter 36 is any suitable commercially available transmitter device capable of sending a signal comprising a text message to a receiving device, such as the receiver 26.

While the selected message is being displayed on the display screen 24, the miniature display screen 34 functions to duplicate the streaming message so that it is readily apparent what message is being broadcast and what is being viewed rearwardly of the vehicle 12.

Similar to that of the display unit 16, the processing unit 18, and thus the transmitter 36 and the miniature display screen 34 disposed therein, is powered either by the battery 40 of the vehicle 12 or it includes its own separate power supply.

As shown in FIG. 1, the processing unit 18 is in electrical communication with the battery 40 of the vehicle 12 by way of a power socket 42b.

As shown in FIG. 2, in an alternative arrangement, the processing unit 18 further comprises a power supply 46. This provides for a wireless processing unit 18 having more flexibility to where the display unit 16 may be controlled from.

In either arrangement, a power switch, not shown, is provided on the body 30 for powering the processing unit 18 on and off so as to not waste battery.

The processing unit 18 is specifically paired to a particular display unit 16 in order to prevent the processing unit 18 from controlling a different, unintended, display unit 16 of a different system 10, such as one located on a nearby passing vehicle. Alternatively, a “master” processing unit 18 may be programmed in order to control a plurality of display units 16. Doing so provides additional benefits for companies attempting to maintain control over multiple display units 16.

As noted above, the system 10 further comprises the relay device 20 in electrical communication with the vehicle bus 14 for receiving information as to the transmission, brakes, and turn signals of the vehicle 12. While the processing unit 18 transmits a number of messages chosen by the user to the display unit 16, there are times when messages should automatically be displayed without instruction by the user. Those messages include alerting those near the vehicle 12 of an upcoming turn once the turn signals have been activated or an abrupt braking to avoid being rear ended. These messages interrupt the previously selected and displayed message to notify others of these alerts.

The relay device 20 includes a transmitter 48 similar to the transmitter 36 disclosed in the processing unit 18. The transmitter 48 in the relay device 20 receives recorded information and transmits that information to either the processing unit 18, and subsequently to the display screen 24, or, alternatively, the information may be sent directly to the display screen 24 in order to display urgent messages. In the case of the brakes, the alert, such as “CAUTION BRAKING,” flashes for approximately 30 seconds or until the driver releases pressure on the brakes, whichever occurs first. The display screen 24 automatically returns to the message that was being displayed previously. The same occurs for the turn signals displaying a different associated message such as “TURNING LEFT” or TURNING RIGHT.”

While the primary purpose of the relay device 20 is to transmit messages to be displayed on the display screen 24 regarding brakes, turning, and the like, the relay device 20 also monitors the transmission of the vehicle 12 in order to power on and off the display unit 16 when the transmission of the vehicle 12 is started and stopped, respectively. This saves the user from having to manually turn the display unit 16 on and off from the exterior of the vehicle 12.

Although not shown in the drawing, the system 10 may further comprise an optional anti-theft program to assist in recovering the vehicle 12 if stolen. The anti-theft program requires that a code be entered on the processing unit 18 once the transmission of the vehicle 12 is turned off to be activated. If the anti-theft program is activated, once the vehicle 12 started and the display unit 16 powered on, the user must re-enter the code on the processing unit 18 to verify the identity of the driver, thereby deactivating the anti-theft program. The code can vary between text, numbers, or even a verbal cue by speaking into the microphone 38 on the processing unit 18 and utilizing the voice recognition function. If the code is not entered within the predetermined time, the driver is notified by a brief audible alarm or chirp. If the code is still not entered after an additional predetermined period of time, the anti-theft program sends a message to the display screen 24 to notify others that the vehicle 12 has been stolen and the police should be notified. The processing unit 18 may further produce an escalating audible alarm in order to deter the driver from continuing in his or her pursuit of stealing the vehicle 12.

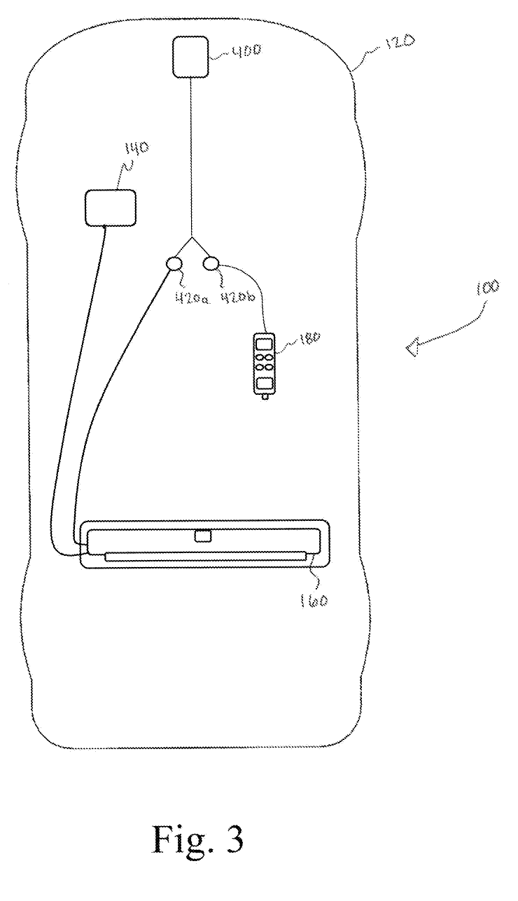

In a second embodiment of the present invention, as shown in FIG. 3, there is provided a vehicle communication system, denoted at 100, for use in a vehicle 120 having a vehicle bus 140.

Here, the system 100, generally, comprises: (a) a display unit 160 for displaying messages and receiving said messages from a remote source; and (b) a processing unit 180 having means for voice recognition and dictation for sending messages to the display unit 160.

The first and second embodiments are identical in every respect except for the fact that the second embodiment operates without the use of the relay device 20. Therefore, either the processing unit 180 or the display unit 160 is in direct electrical communication with the vehicle bus 140 in order to receive information regarding the transmission, brakes, and turn signals. As shown in FIG. 3, the display unit 160 is in electrical communication with the vehicle bus 140.

While it is to be understood that the display unit 160 and processing unit 180 may comprise their own power supply, as discussed in FIG. 2 of the first embodiment, instead of connecting to the battery 400 of the vehicle 120 via power inputs 420a, 420b, it would not provide a fully wireless system as either the processing unit 180 or the display unit 160 is still required to be connected to the vehicle bus 140 where the relay device 20 is not employed.

Alternatively, as newly manufactured vehicles are developing more means for wireless connectivity, such as Bluetooth®, WiFi™, and the like, it is not outside of the scope of the present invention that either the processing unit 180 or the display unit 160 may be connected to the vehicle bus 140 using one of the aforementioned technologies without having to modify the components of the vehicle 120 in any way.

Regardless of which embodiment of the present invention is employed, the above descriptions and associated figures are not to be limiting with regards to the possible connections between the display unit 16 and processing unit 18. As described above, there are numerous connections that can be made between the components in order to deliver power and the appropriate messages to the display screen 24. It is to be understood that the one of ordinary skill in the art could reasonably interconnect the components of the system 10 to provide one suitable for the particular problem where the components exhibit either a wireless or wired arrangement where necessary.

From the above, it is to be appreciated that defined herein is a new and unique vehicle communication system that provides ease of operation and improved safety measures.

Having thus described the invention, what is claimed is:

1. A vehicle communication system for use in a vehicle having a vehicle bus, the vehicle communication system comprising:
(a) a display unit including:
(i) a housing having a plurality of sides and an open interior;
(ii) a display screen for displaying a message provided within one of the sides of the housing;
(iii) a receiver for receiving a remote signal disposed within the interior of the housing and in electrical communication with the display screen;
(b) a processing unit including:
(i) means for voice recognition and dictation;
(ii) a transmitter for sending a signal to the receiver;
(iii) a plurality of controls for selecting and inputting a message disposed on the processing unit and in electrical communication with the transmitter;
(c) a relay device in electrical communication with the vehicle bus for receiving information as to the brakes, turn signals, and transmission of the vehicle, the relay device sending a signal to the receiver of the display unit in order to power the display screen and the receiver when the transmission of the vehicle is started and displaying a predetermined message when the brakes or turn signals are engaged.

2. The vehicle communication system of claim 1, wherein the display screen and the receiver are powered by the battery of the vehicle.

3. The vehicle communication system of claim 1, wherein the display unit further comprises a first power supply thereby powering the display screen and the receiver.

4. The vehicle communication system of claim 1, wherein the display unit further includes a plurality of memory banks, each of the plurality of memory banks storing a plurality of stored messages.

5. The vehicle communication system of claim 4, wherein the plurality of memory banks comprises at least three memory banks.

6. The vehicle communication system of claim 4, wherein each of the plurality of memory banks includes a filtering system for declining messages that are defined as vulgar, racist, and/or obscene.

7. The vehicle communication system of claim 1, wherein the display unit is disposed within a protective casing, the protective casing mounted to the vehicle.

8. The vehicle communication system of claim 7, wherein the display unit is waterproof when disposed within the protective casing.

9. The vehicle communication system of claim 1, wherein the receiver of the display unit is capable of receiving a signal from an electronic device selected from the group consisting of a mobile phone, tablet, and computer.

10. The vehicle communication system of claim 1, wherein the processing unit is powered by the battery of the vehicle.

11. The vehicle communication system of claim 1, wherein the processing unit further comprises a second power supply thereby powering the transmitter.

12. The vehicle communication system of claim 1, wherein the processing unit includes a miniature display screen replicating the message currently being displayed on the display screen of the display unit in substantially real-time.

13. The vehicle communication system of claim 12, wherein the processing unit is in electrical communication with the battery of the vehicle thereby powering the miniature display screen and the receiver.

14. The vehicle communication system of claim 12, wherein the processing unit further comprises a second power supply thereby powering the miniature display screen and the transmitter.

15. The vehicle communication system of claim 1, wherein the controls of the processing unit correspond to numbers 0-9 and letters A-Z.

16. The vehicle communication system of claim 1, wherein the processing unit selects predetermined messages and stores new messages based on voice commands.

17. The vehicle communication system of claim 1 further including an anti-theft system that is activated if a passcode is not entered into the processing unit within a predetermined period of the display unit being activated.

18. A vehicle communication system for use in a vehicle having a vehicle bus, the vehicle communication system comprising:
(a) a display unit including:
(i) a housing having a plurality of sides and an open interior;
(ii) a display screen for displaying a message provided within one of the sides of the housing;
(iii) a receiver for receiving a remote signal disposed within the interior of the housing and in electrical communication with the display screen;
(b) a processing unit including:
(i) means for voice recognition and dictation;
(ii) a transmitter for sending a signal to the receiver;
(iii) a plurality of controls for selecting and inputting a message disposed on the processing unit and in electrical communication with the transmitter; and
wherein the receiver receives a signal from the vehicle bus in order to power the display screen and the receiver when the transmission of the vehicle is started and to display a predetermined message when the brakes or turn signals are engaged.

19. The vehicle communication system of claim 18, wherein the display unit is in electrical communication with the vehicle bus for receiving information as to the brakes, turn signals, and transmission of the vehicle.

20. The vehicle communication system of claim 18, wherein the processing unit is in electrical communication with the vehicle bus for receiving information as to the brakes, turn signals, and transmission of the vehicle.
